(19) United States
(12) Patent Application Publication
(10) Pub. No.: US 2023/0356338 A1
(43) Pub. Date: Nov. 9, 2023

(54) EQUIPPING DEVICE, MACHINE TOOL AND METHOD FOR LOADING OR UNLOADING TOOLS

(71) Applicant: CHIRON Group SE, Tuttlingen (DE)

(72) Inventors: Michael EBLE, Fridingen (DE); Karl-Heinz RAFFKE, Aldingen (DE); Claus EPPLER, Messstetten (DE)

(21) Appl. No.: 18/137,147

(22) Filed: Apr. 20, 2023

(30) Foreign Application Priority Data
May 9, 2022 (DE) 10 2022 111 480.5

(51) Int. Cl. B23Q 3/155

(52) U.S. Cl. CPC B23Q 3/1554; B23Q 2003/155407

(57) ABSTRACT

An equipping device for a machine tool comprises a tool shuttle that is movable between a first transfer position and a second transfer position, a provision location for insertion or removal of a tool, and a tool carrying unit that is associated with the tool shuttle. The tool carrying unit comprises at least one gripping mechanism that is adapted to grip a tool to be transferred and to secure it to the tool shuttle. The provision location is accessible for the tool shuttle in the first transfer position. The tool shuttle is configured to exchange a tool between the provision location and a magazine location of a tool magazine. The magazine location is accessible for the tool shuttle in the second transfer position. The gripping mechanism comprises a guide element that is movable relative to a base body of the tool shuttle and a securing element that is movable relative to the guide element. At least the guide element is movable parallel to a longitudinal axis of the tool. A machine tool comprises an equipping device. A method for tool change uses an equipping device.

### CROSS-REFERENCE TO RELATED APPLICATIONS

This application claims priority to German patent application 10 2022 111 480.5, filed on 9 May 2022. The entire content of this priority application is incorporated herein by reference.

### BACKGROUND

The present disclosure relates to an equipping device for tools, a machine tool that is provided with an equipping device, and to a method for loading or unloading tools for a machine tool.

DE 102 36 342 A1 discloses a device for loading a vertically oriented chain magazine, which is arranged to accommodate horizontally oriented tools. The loading device comprises a swivel drive, which transfers tools between an externally accessible loading position and an intermediate position. Furthermore, a transport device is provided, which transfers tools between the intermediate position and the chain magazine.

WO 2014/048707 A1 discloses a transfer gripper for transferring a vertically oriented tool between two positions, for example for loading a tool magazine or for transferring a tool between two tool magazines. The transfer gripper is arranged to grip a tool shank internally, wherein two opposing, obliquely oriented fingers are provided for this purpose, which in an engaged state can engage behind an undercut in the tool shank that is formed by a shoulder. The two fingers are arranged on opposite beams, which can be moved in opposite directions with respect to the tool by means of slanted guides. The two fingers can each be moved in a plane that is oriented at an angle of approximately 45° to 50° with respect to a longitudinal axis of the tool.

DE 10 2018 122 165 A1 discloses a transfer magazine for tools, which comprises a tool storage for holding a plurality of tools and a tool changer, by means of which tools can be changed into a tool spindle. Furthermore, a tool relocation device is provided, by means of which tools can be transferred between the tool storage and the tool changer. The tool relocation device enables a vertical removal movement and insertion movement for the tools.

DE 10 2009 041 075 A1, U.S. Pat. No. 4,920,632 A, DE 40 33 036 A1 and U.S. Pat. No. 11,311,977 B2 disclose arrangements of tool transfer devices with tool shuttles. DE 20 2007 016 375 U1 discloses a gripping mechanism for gripping tools at their conical surface.

Tool handling plays a major role in the automation of machine tools. An automatic tool change expands the range of applications for the machine tool. workpieces can be extensively (ideally completely) machined in a single clamping setup. Furthermore, an automatic tool change allows the replacement of worn tools without major losses in productivity.

Tool mounts are usually used to clamp a tool in a tool holder, for example a tool holder of a tool spindle. Tool mounts are usually conical in shape, for example as a hollow shank taper (HSK). To provide a plurality of tools for a machine tool, tool magazines are usually provided, which comprise a plurality of magazine locations for tools.

Tools usually comprise handling portions, for example a handling groove on an outer circumference of a tool shank. Via the handling groove, a tool can be held and moved by a gripper, for example. Further, a tool can be seated in the receiving groove in a magazine location via the handling groove. In such a case, the handling groove can no longer be used for other handling units.

It has been observed that the manual loading of tool magazines, such as chain magazines, is sometimes associated with increased effort for an operator. This refers, for example, to correct alignment (axial orientation, rotational orientation) of the tool in relation to a magazine location. Especially in the case of relatively large tools with large shank dimensions, the considerable dead weight of the tool is an additional factor. By way of example, the handling of tools with a so-called HSK-100 (for example HSK-A 100) hollow shank taper is already made more complicated because the shaft alone (without tool section) weighs several kilograms. A tool with HSK-A 100 interface can have a weight of over 20 kg.

Tools with a large-diameter shank are naturally suitable for transmitting high torques. Consequently, a high stock removal rate can be achieved with them. The dimensions and weight of such tools must of course be taken into account when handling and stocking them.

There is still a need for automation solutions for the provision of tools for machine tools, for instance in connection with equipping tool magazines.

In view of this, it is an object of the present disclosure to present an equipping device for a tool magazine of a machine tool, which simplifies the loading and unloading of tools.

It is a further object of the present disclosure to present an equipping device, which is intended to serve as an interface between the machine tool and the environment.

It is a further object of the present disclosure to present an equipping device, which facilitates the loading and unloading of heavy tools.

It is a further object of the present disclosure to present an equipping device, which is be suitable for manual supply by an operator.

It is a further object of the present disclosure to present a machine tool that is provided with an equipping device.

It is a further object of the present disclosure to present a corresponding method for loading or unloading tools in a machine tool is to be presented.

### SUMMARY

According to a first aspect, these and other objects are achieved by an equipping device for a tool magazine of a machine tool, comprising:
a tool shuttle that is movable between a first transfer position and a second transfer position,
a provision location for insertion or removal of tools,
a tool carrying unit that is associated with the tool shuttle and comprises at least one gripping mechanism that is arranged to grip a tool to be transferred and to secure it to the tool shuttle,
wherein the tool shuttle is configured to exchange the tool between the provision location and a magazine location of a tool magazine,
wherein the provision location is accessible for the tool shuttle in the first transfer position,
wherein the magazine location is accessible for the tool shuttle in the second transfer position,
wherein the gripping mechanism comprises a guide element that is movable relative to a base body of the tool shuttle and a securing element that is movable relative to the guide element, and
wherein the guide element is movable parallel to a longitudinal axis of the tool.

According to another aspect, the above and other objects are achieved by a machine tool comprising:
a frame,
at least one workpiece support,
at least one tool spindle that is movable relative to the workpiece support,
at least one tool magazine that is associated with the tool spindle for providing a plurality of tools, and
at least one equipping device for loading and unloading the tool magazine, the at least one equipping device comprising:
   a tool shuttle that is movable between a first transfer position and a second transfer position,
   a provision location for insertion or removal of tools,
   a tool carrying unit that is associated with the tool shuttle and comprises at least one gripping mechanism that is arranged to grip a tool to be transferred and to secure it to the tool shuttle,
   wherein the tool shuttle is configured to exchange the tool between the provision location and a magazine location of the tool magazine,
   wherein the provision location is accessible for the tool shuttle in the first transfer position,
   wherein the magazine location is accessible for the tool shuttle in the second transfer position,
   wherein the gripping mechanism comprises a guide element that is movable relative to a base body of the tool shuttle and a securing element that is movable relative to the guide element,
   wherein the guide element is movable parallel to a longitudinal axis of the tool, and
wherein the provision location is externally accessible via an access opening for inserting and removing tools.

According to another aspect, the above and other objects are achieved by a method for loading or unloading tools in a machine tool, comprising the steps of:
providing an equipping device for a tool magazine of a machine tool, the equipping device comprising:
   a tool shuttle that is movable between a first transfer position and a second transfer position,
   a provision location for insertion or removal of tools,
   a tool carrying unit that is associated with the tool shuttle and comprises at least one gripping mechanism that is arranged to grip a tool to be transferred and to secure it to the tool shuttle,
   wherein the tool shuttle is configured to exchange the tool between the provision location and a magazine location of a tool magazine,
   wherein the provision location is accessible for the tool shuttle in the first transfer position,
   wherein the magazine location is accessible for the tool shuttle in the second transfer position,
   wherein the gripping mechanism comprises a guide element that is movable relative to a base body of the tool shuttle and a securing element that is movable relative to the guide element, and
   wherein the guide element is movable parallel to a longitudinal axis of the tool,
loading a tool into the provision location,
positioning the tool shuttle in the first transfer position so that the tool is accessible for the tool carrying unit,
controlling the tool carrying unit to move the guide element and the securing element to grip the tool and to secure it to the tool shuttle,
moving the tool shuttle to the second transfer position where a magazine location of the tool magazine is available, and
handing over the tool to the magazine location of the tool magazine, comprising a movement of the guide element and the securing element.

According to another aspect, the above and other objects are achieved by an equipping device for a machine tool, for instance for a tool magazine of a machine tool, wherein the equipping device comprises:
a tool shuttle that is movable between a first transfer position and a second transfer position,
a provision location, for instance an externally accessible provision location, for insertion or removal of a tool, wherein the provision location is accessible for the tool shuttle in the first transfer position,
wherein the tool shuttle is adapted to exchange a tool between the provision location and a magazine location of a tool magazine, wherein the magazine location is accessible for the tool shuttle in the second transfer position, and
a tool carrying unit that is associated with the tool shuttle and comprises at least one gripping mechanism that is arranged to grip a tool to be transferred and to secure it to the tool shuttle,
wherein the gripping mechanism comprises a guide element that is movable relative to a base body of the tool shuttle and a securing element that is movable relative to the guide element, and
wherein at least the guide element is movable parallel to a longitudinal axis of the tool.

The equipping device is used, for example, to load a tool magazine. The equipping device is usually not used for a direct transfer of a tool between the provision location and a tool spindle. Instead, the equipping device is arranged, for example, in a rear area of the machine (for example, on the loading side) and enables loading or unloading of tools in relation to at least one tool magazine of the machine tool. The equipping device can transfer tools with the tool shuttle between the first transfer position and the second transfer position. Thus, new tools can be inserted into a tool magazine. However, tools (for example, used or worn tools) can also be discharged from the tool magazine.

At least the guide element is movable parallel to the longitudinal axis of the tool. By way of example, the guide element is movable along the longitudinal axis of the tool in order to grip or release the tool. In an exemplary embodiment, both the guide element and the securing element are movable parallel to the longitudinal axis, for instance along the longitudinal axis, of the tool.

The tool magazine is arranged as a chain magazine, at least in exemplary embodiments. In an exemplary embodiment, the chain magazine is used to provide tools that can be exchanged directly between the chain magazine and the tool spindle, for example according to a so-called pick-up process, in which the tool spindle with its tool holder is configured to pick up tools from a transfer position or to dispose them there.

In exemplary embodiments, the tools are oriented in a hanging manner at least in the tool magazine and in the tool shuttle. The longitudinal axis of the tools is oriented vertically in such an embodiment. Usually, in this embodiment, an operational area (for example, cutting edge) of the tools is oriented downward.

In exemplary embodiments, the equipping device is used for handling large-diameter tools, for example tools with a hollow shaft taper (hollow shank taper) of the size HSK-100 (for example HSK-A 100). Such a tool comprises a handling portion with a diameter of about 100 mm. Confer exemplary tool dimensions in—German Institute for Standardization—DIN 69893-1 (edition 2011-04). Other designs of hollow shanks are conceivable. Sizes other than HSK-A 100 are also conceivable, for example HSK-A 63 or HSK-A 125. Other designs than hollow shank tapers are also conceivable, for example so-called steep taper shanks.

In an exemplary embodiment, the tool magazine, which can be equipped by means of the equipping device, comprises 36 or 52 magazine positions. The tool magazine is, for example, a horizontally oriented chain magazine that extends in a horizontal plane at least between the second transfer position of the equipping device and a further transfer position (third transfer position) for transferring tools between the tool magazine and the tool spindle. The magazine positions can be individually loaded with the equipping device. Tools can be loaded or unloaded. The respective magazine location in the second transfer position is provided by a drive of the tool magazine.

According to another exemplary embodiment, the guide element is arranged to move into a hollow shaft of the tool in order to take up a tool. According to this embodiment, the guide element can engage in the tool. The hollow shaft may also be referred to as a cup, in which the guide element engages. According to a further exemplary embodiment, the securing element is also arranged to move into the hollow shaft of the tool in order to receive the tool. By way of example, this is done together with the guide element.

According to another exemplary embodiment, the securing element is movable relative to the guide element in order to secure a gripped tool positively or non-positively at the guide element. By a movement in the opposite direction, a previously secured tool can be released from the guide element when the securing element is moved accordingly. As used herein, positive securing relates to positive fit or positive locking. As used herein, non-positive securing relates to force fit or force locking.

According to another exemplary embodiment, the securing element is movable parallel to the longitudinal axis of the tool relative to the guide element in order to engage at least one latching portion of the tool with at least one latching element. This relative movement between the securing element and the guide element allows the tool to be secured to the tool carrying unit of the tool shuttle by the gripping mechanism inside the hollow shaft.

The engaged latching elements can be released by a movement in the opposite direction so that releasing is possible, at least in exemplary embodiments. The latching elements are, for example, latching balls. The latching and the associated positional securing are performed, for example, in a form-fitting manner. By way of example, the latching portion is formed by an undercut in the interior of the hollow shaft, into which at least one latching element can engage. The undercut can also be referred to as a shoulder. By way of example, three or more latching elements are distributed in a circle around the longitudinal axis. When the latching elements are forced outwards by the securing element, the tool can be held and secured in a defined manner via its hollow shaft.

According to another exemplary embodiment, the guide element is part of a guide cylinder that is arranged on the base body. The guide cylinder is arranged, for example, as a fluidically controlled cylinder. The control is usually done with compressed air, but control with a hydraulic fluid is also conceivable.

According to another exemplary embodiment, the securing element is part of a securing cylinder that is coupled to the guide element. The securing cylinder is arranged, for example, as a fluidically controlled cylinder. The control is usually done with compressed air, but control with a hydraulic fluid is also conceivable.

According to another exemplary embodiment, at least the guide element or the securing element is part of a piston that is movable in a carrying housing parallel to the longitudinal axis of the tool. Accordingly, there is, for example, a guide piston or a securing piston. In an exemplary embodiment, the guide element and the securing element are oriented concentrically with respect to each other and concentrically with respect to the longitudinal axis of the tool.

According to another exemplary embodiment, the guide element is formed at an end of a guide piston that is facing the tool. According to another exemplary embodiment, the guide element is oriented concentrically to the longitudinal axis of the tool when the tool is gripped.

According to another exemplary embodiment, the securing element is formed at an end of a securing piston that is facing the tool. According to another exemplary embodiment, the securing element is aligned concentrically to the guide element. According to another exemplary embodiment, the securing piston is arranged (radially) inside the guide piston.

According to an exemplary embodiment, the guide piston is movable relative to a base body of the tool shuttle. According to an exemplary embodiment, the securing piston is movable relative to the guide piston.

According to another exemplary embodiment, the securing piston projects through the guide piston with its end that is facing away from the mold, wherein the end of the securing piston that is facing away from the tool comprises a cantilever, which interacts with a position monitoring unit that is arranged on the base body. In this way, robust position monitoring is provided, for example via at least one proximity sensor. The position monitoring can be performed by externally accessible sensors that are not located inside the guide cylinder. This simplifies maintenance, repair and the like.

According to another exemplary embodiment, the position monitoring unit is configured to detect a position of the guide piston and a position of the securing piston via the cantilever. In this way, it can be detected whether a tool is held and secured by the gripping mechanism of the tool carrying unit.

According to another exemplary embodiment, the tool carrying unit is movable together with the tool shuttle between the first transfer position and the second transfer position. By way of example, the tool shuttle performs a translational movement between the first transfer position and the second transfer position. In an exemplary embodiment, the tool magazine is not directly available for an operator for loading or unloading tools. Instead, the equipping device enables a defined loading of the tool magazine.

According to another exemplary embodiment, the gripping mechanism, for instance the guide element thereof, grips the tool while omitting a handling portion of the tool that is arranged on a tool shank circumference. In other words, the (outer) handling portion remains accessible for other handling technology. This allows, for example, a defined placement of a tool in the tool magazine. When the gripping mechanism is actuated, the handling portion remains unobstructed in an exemplary embodiment. The gripping mechanism itself does not engage the tool there.

According to another exemplary embodiment, the tool rests at the provision location with a handling portion on a stationary provision support. In other words, a tool can be placed on the provision support at the provision location and moved from there from the first transfer position to the second transfer position by means of the tool carrying unit of the tool shuttle.

According to another exemplary embodiment, the tool is held in the tool magazine in the magazine location via the handling portion. Then, for example, the tool spindle can engage with the hollow shaft of the tool in order to remove the tool from the tool magazine by means of a pick-up or in order to insert a tool into an empty magazine location of the tool magazine.

According to another exemplary embodiment, at least one mechanical orientation guide for ensuring a rotational orientation of an inserted tool or at least one proximity sensor for detecting an inserted tool is arranged at the provision location. In this way, the tool can be transferred with a defined orientation (rotational orientation). In this way, insertion and locking in the tool magazine can be simplified. Furthermore, a defined orientation allows, for example, a simplified readout of a tool identifier (RFID chip, barcode or similar) that is oriented in a defined manner.

By way of example, a first proximity sensor is used to detect the presence of a tool, for example by detecting the presence of its hollow shaft. By way of example, a further proximity sensor is used to check whether a specific rotational orientation is actually present on the tool. This is done, for example, by aiming at certain geometries on the tool, which involve, for example, a recess that serves as a seat for a tool identifier. In addition or alternatively to the second proximity sensor, a sensor for detecting/reading the tool identifier can be installed.

According to another exemplary embodiment, at the provision location at least one stop for a tool that is presented in the first transfer position is provided, wherein the stop can be brought by the tool shuttle from a locking position into a release position. The stop is arranged, for example, as a movable stop. In this way, a tool can be provided in a defined manner at the provision location in the first transfer position. This simplifies the gripping of the tool with the tool carrying unit. When the tool shuttle approaches the first transfer position, the tool shuttle can move the at least one stop so that the gripped tool is removable from the provision location towards the second transfer position. Such actuation of the at least one stop is performed, for example, via sliding pieces that are provided on the tool shuttle.

In an exemplary embodiment, the tool shuttle can move the at least one movable stop against the force of a biasing element. When the tool shuttle is away from the provision location, the at least one stop is in a locking position. When the shuttle is positioned at the provision location in the first transfer position, the at least one stop is in a releasing position.

According to another aspect, the above and other objects are achieved by a machine tool comprising:
a frame,
at least one workpiece support,
at least one tool spindle that is movable relative to the workpiece support,
at least one tool magazine that is associated with the tool spindle for providing a plurality of tools, which can be gripped by the tool spindle in a pick-up process, for instance, and
at least one equipping device according to at least one of the embodiments described herein, by which tools can be inserted into or removed from the tool magazine,
wherein the provision location of the equipping device is accessible for loading or unloading tools.

The equipping device is used to introduce tools into the tool magazine from outside, for instance. This applies, for example, to individual tools that are provided manually or automatically at the provision location. Conversely, tools can be removed in this way. The tool magazine is arranged, for example, as a chain magazine, for instance as a horizontally oriented chain magazine that permits a pick-up tool change with a vertically oriented spindle.

According to another exemplary embodiment, the machine tool comprises a first tool magazine and a second tool magazine, and exactly one equipping device, wherein the equipping device is operatively coupled to the first tool magazine for loading or unloading tools, and wherein tools are transferable by the tool spindle between the first tool magazine and the second tool magazine.

In this way, a transfer between the first tool magazine and the second tool magazine can take place within the machine tool by means of the tool spindle. One of the two tool magazines is equipped from the outside using the equipping device. The other tool magazine can be equipped immediately using the tool spindle for a tool transfer between the two tool magazines.

In an exemplary embodiment, the machine tool comprises a tool spindle and two tool magazines, both of which can be reached by the tool spindle for a tool change. The tool change is carried out in a pick-up process, for instance. At least one of the two workpiece magazines can be loaded with an equipping device according to one of the embodiments mentioned herein. The tool magazines may be arranged side by side, one above the other, and/or at least partially offset from each other. The tool spindle can be used for a sorting process.

In another exemplary embodiment, the machine tool comprises two tool spindles and two tool magazines. In such an embodiment, it is conceivable to provide a separate equipping device for each of the two tool magazines. It is also conceivable to provide an equipping device for only one of the two tool magazines. workpiece transfer between the two tool magazines then takes place via one of the two tool spindles.

According to another aspect, the above and other objects are achieved by a method of loading or unloading tools in a machine tool according to at least one of the embodiments described herein, comprising the following steps:
loading a tool into the provision location,
positioning the tool shuttle in the first transfer position so that the tool is accessible for the tool carrying unit,
controlling of the tool carrying unit to move the guide element and the securing element to grip the tool and to secure it to the tool shuttle,
moving the tool shuttle to the second transfer position, where a magazine location of the tool magazine is available, and
handing over the tool to the magazine location of the tool magazine, comprising a movement of the guide element and the securing element.

The process can also be used for unloading tools. Usually, the process is suitable for both loading and unloading. In the case of two tool magazines, the process can include a step of rearranging and/or transferring tools between the two tool magazines, wherein this is done by the tool spindle using a pick-up process.

It is to be understood that the previously mentioned features and those mentioned in the following may not only be used in the respectively indicated combination, but also in other combinations or as isolated features without leaving the spirit and scope of the present disclosure.

### BRIEF DESCRIPTION OF THE DRAWINGS

Further features and advantages will be apparent from the following description of several exemplary embodiments with reference to the drawings, wherein:

FIG. 1: is a perspective view of a machine tool;

FIG. 2 is a top view of a machine tool having a tool magazine and an equipping device;

FIG. 3: is another top view of a machine tool having a tool magazine and an equipping device;

FIG. 4: is another top view of a machine tool having a tool magazine and an equipping device;

FIG. 5: is a perspective view of an equipping device;

FIG. 6: is a partial view of the equipping device shown in FIG. 5 to illustrate a provision location;

FIG. 7: is another partial perspective view of the equipping device according to FIG. 5;

FIG. 8: is a partial view of the provision location of an equipping device to illustrate a stop in a locked position;

FIG. 9: is a partial view of the provision location based on FIG. 8 to illustrate a stop in a release position;

FIG. 10: is a sectional view through a gripping mechanism of a tool carrying unit of a tool shuttle in a disengaged position;

FIG. 11: is a further sectional view based on FIG. 10 in a position of the gripping mechanism engaged in a tool, still without latching;

FIG. 12: a further sectional view based on FIGS. 10 and 11 in a fully engaged position of the gripping mechanism, with latching;

FIG. 13: is another sectional view of the tool shuttle having a tool carrying unit and a gripping mechanism as illustrated in FIGS. 10-12 in a different orientation;

FIG. 14: is a perspective view of a tool shuttle with a gripping mechanism and a tool that is held by the gripping mechanism; and

FIG. 15: is a simplified block diagram illustrating an exemplary embodiment of a method for loading or unloading a tool in a machine tool.

### EMBODIMENTS

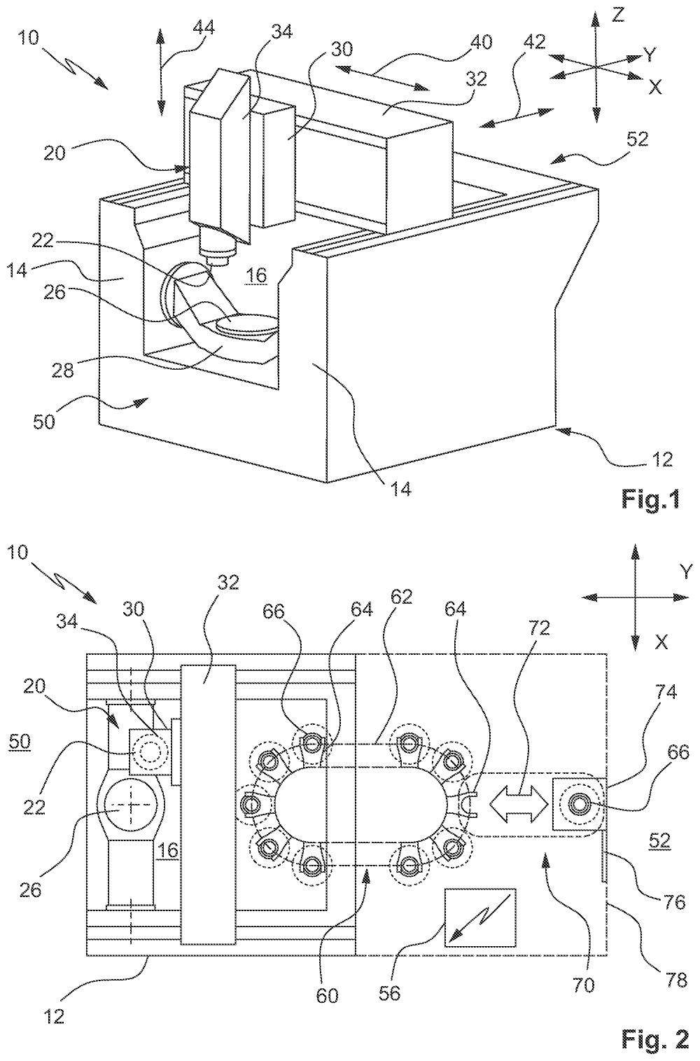

FIG. 1 shows a perspective view of the basic structure of a machine tool that is overall designated by 10. In addition, FIGS. 2-4 show various top views of machine tools 10. In the exemplary embodiments according to FIGS. 1-4, the machine tool 10 is arranged as a so-called gantry machine. This is not to be understood in a limiting sense. Configurations as portal design (for example with fixed portal) or as moving column design are also conceivable.

In at least some of the Figures, a Cartesian coordinate system X-Y-Z is shown for illustrative purposes. The coordinate system is used to illustrate basic orientations and movement axes of the machine tool 10 and its components. An axis designated by X generally indicates a longitudinal extension. An axis designated by Y generally indicates a depth extension. In the exemplary embodiment, the axes X and Y together define a horizontal plane. An axis designated by Z generally indicates a height extension. The coordinate system X-Y-Z is primarily for illustration purposes and is not to be understood in a limiting sense. It is understood that other coordinate systems can also be used to describe the machine tool 10 and its components. The person skilled in the art can carry out corresponding transformations.

In the embodiment shown in FIG. 1, the machine tool 10 comprises a frame 12, which can also be referred to as a base or bed. In the design shown as a gantry machine, the frame 12 comprises two lateral cheeks 14, on the upper side of which guides (Y-guides) are formed. The machine tool 10 defines a workspace 16, in which workpieces can be machined, for instance by metal-cutting machining. Usually, the working space 16 is enclosed (not shown in FIG. 1).

The machine tool 10 comprises a tool spindle 20 with a tool holder 22, which is arranged for receiving a tool. In the exemplary embodiment, the tool spindle 20 is oriented vertically. In FIG. 1, the tool spindle 20 is configured as a hanging spindle. Tools can be driven about a vertically oriented spindle axis. The tool spindle 20 is movable relative to a workpiece support 26 to machine a workpiece (not shown in FIG. 1) located there. In the exemplary embodiment, the workpiece support 26 is arranged on a swivel bridge 28, which is mounted on both sides on the cheeks 14 of the frame 12. Other designs are conceivable. In FIG. 1, the tool spindle 20 is arranged as a hanging spindle.

The tool spindle 20 is movable in three linear axes relative to the workpiece support 26. For this purpose, an X-carriage 30, a Y-carriage 32 and a Z-carriage 34 are provided in the embodiment. The Y-carriage 32 is seated on the cheeks 14 of the frame 12. The X-carriage 30 is arranged on the Y-carriage 32 to be linearly moveable. The Z-carriage 34 is arranged on the X-carriage 30 to be linearly moveable. The Z-carriage carries the tool spindle 20. The X-carriage 30 carries the Z-carriage 34. The Y-carriage 32 carries the X-carriage 30.

The X-carriage 30 is movable in translation in an X axis 40 (X-direction) along the Y-carriage 32. The Y-carriage 32 is movable in translation in a Y-axis 42 (Y direction) along the cheeks 14 of the frame 12. The Z-carriage 34 is movable in a Z-axis 44 (Z-direction) along the X-carriage 30. The Z-carriage 34 is movable vertically. The X-carriage 30 and the Y-carriage 32 are movable horizontally. In the exemplary embodiment, the swivel bridge 28 (A-axis, cf. swivel movements about the X-axis) and the workpiece support 26 (C-axis, cf. swivel movements about the Z-axis) provide further (rotational) movement axes. In total, 5-axis machining is possible with the machine tool 10. Other designs of the machine tool 10 are conceivable, for example with 4-axis kinematics, 3-axis kinematics or the like.

For illustrative purposes, an arrow 50 indicates a machining side in FIG. 1, which can also be referred to as the front side. An opposite arrow 52 indicates a tool loading side, which can also be referred to as the rear side. This is not to be understood in a limiting sense.

FIGS. 2-4 show top views of various configurations of machine tools 10. The basic configuration of the machine tool 10 shown in FIG. 2 corresponds to the design illustrated in FIG. 1. In FIG. 2, 56 indicates a control unit of the machine tool 10. The control unit 56 controls components of the machine tool 10, which relates for instance to the machining of workpieces, but also a workpiece change, tool change, tool management, position monitoring, control of auxiliary units, etc.

In addition, a tool magazine 60 is shown by means of a schematic representation, which is for instance arranged as a chain magazine 62. The tool magazine 60 comprises a plurality of magazine positions 64 that are used to hold tools 66. In the embodiment shown in FIG. 2, the tool magazine 60 is oriented in a horizontal plane. Tools 66 held in magazine spaces 64 of the tool magazine 60 are oriented vertically. In this way, the tool spindle 20 with its tool holder 22 can remove tools 66 from the tool magazine 60 in a pick-up process and place them there as needed. The tool spindle 20 can remove or dispose tools 66 from above.

An equipping device 70 is provided for loading the tool magazine 60. The equipping device 70 is configured to transfer tools 66 between an access opening 74 and the tool magazine 60, cf. an arrow designated by 72. Tools 66 can be provided at the access opening 74 and can be loaded therefrom by the equipping device 70 into an empty magazine location 64 of the tool magazine 60, which is provided by the tool magazine 60 there.

In the exemplary embodiment according to FIG. 2, the access opening 74 of the equipping device 70 is arranged at the rear side (tool loading side 52) of the machine tool 10. The access opening 74 can be closed by a door 76, by way of example. Tools 66 can be manually inserted into the access opening 74 and disposed there for further handling with the equipping device 70. Furthermore, an enclosure 78 is indicated by a dashed line in FIG. 2. The enclosure 78 surrounds at least partial sections of the machine tool 10.

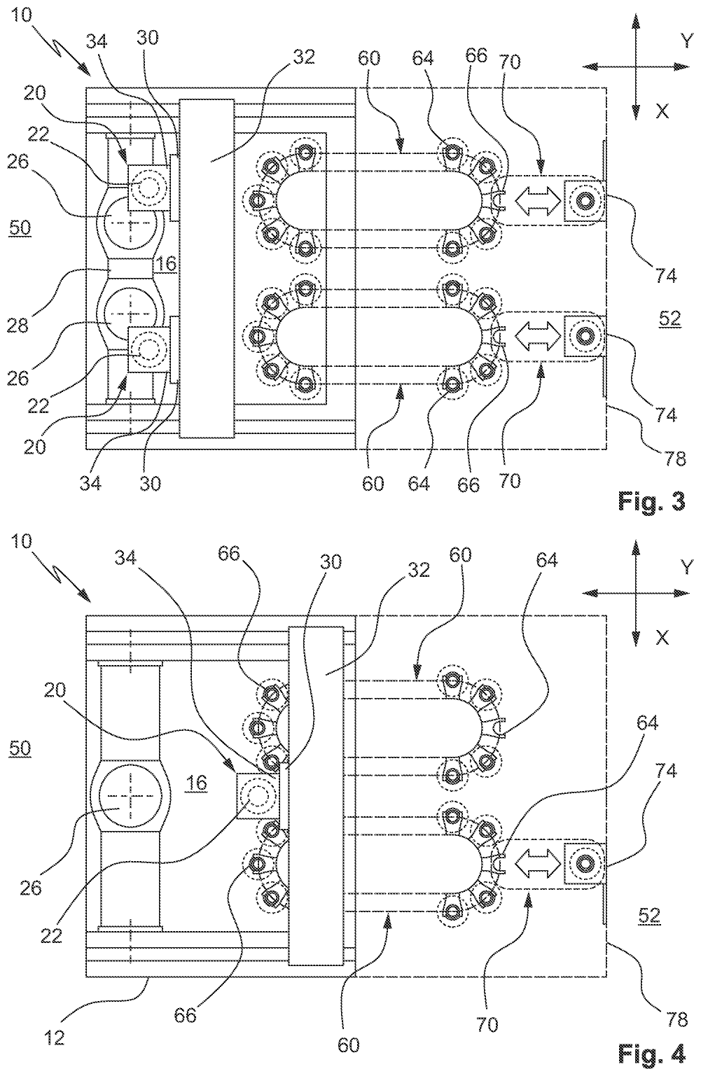

FIG. 3 shows a schematic top view of a machine tool 10 having a double spindle configuration. Two tool spindles 20, each provided with a tool holder 22, are arranged at a distance from each other via a Z-carriage 34 and an X-carriage 30 on a common Y-carriage 32. In the exemplary embodiment according to FIG. 3, the two tool spindles 20 are movable independently of each other in the X-direction. However, a software coupling of the traverse movements can be used. A workpiece support 26 is assigned to each of the two tool spindles 20 on the swivel bridge 28. In this way, two workpieces can be machined together (synchronously).

The machine tool 10 according to FIG. 3 comprises two tool magazines 60, each of which is respectively assigned to one of the two tool spindles 20. An equipping device 70, which can be loaded with tools 66 via an access opening 74, is provided for loading each tool magazine 60.

FIG. 4 shows a schematic top view of a machine tool 10 with a single tool spindle 20 and a single workpiece support 26. Two tool magazines 60 are arranged next to each other in a rear area behind the work area 16 of the machine tool 10. Both tool magazines 60 are accessible to the tool spindle 20 for a pick-up change. Only one of the two tool magazines 60 is coupled to an equipping device 70, the access opening 74 of which can be reached via the tool loading side 52 in the rear area of the machine tool 10. However, with the present configuration, tools 66 can also be fed into (or discharged from) the other tool magazine 60. In such a case, a transfer of tools 66 takes place between the two adjacent tool magazines 60, which is accomplished by the tool spindle 20. In this way, a sorting process can also be carried out.

It is understood that the embodiments of the equipping device 70 illustrated in FIGS. 2-4 do not necessarily involve an arrangement of the access opening 74 on a rear tool loading side 52 that is opposite the machining side 50 (front side). The equipping device 70 can also be coupled laterally to a tool magazine 60.

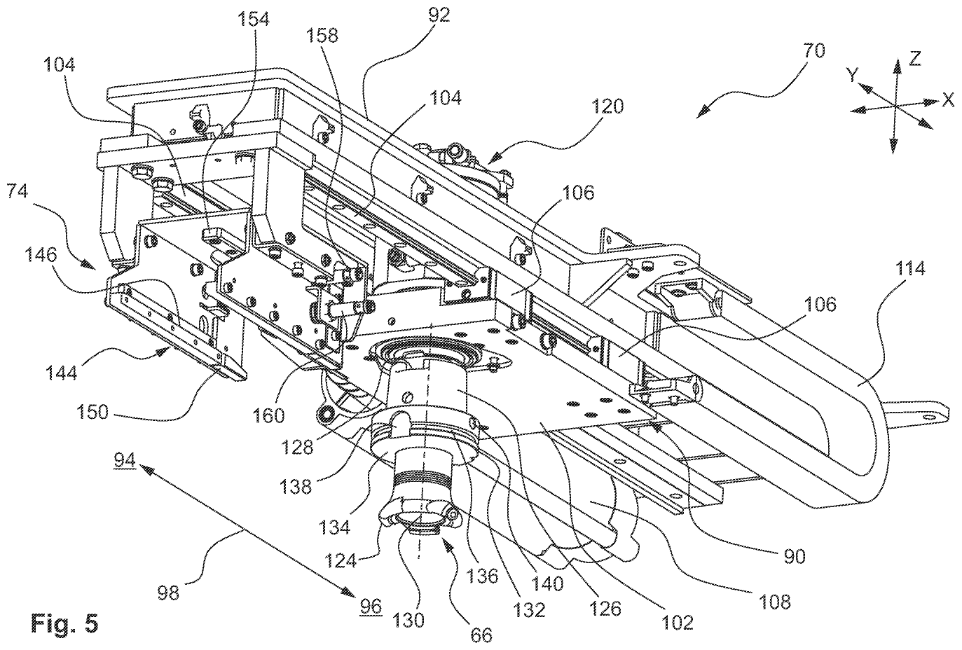

Based on the configurations of machine tools 10 illustrated in FIGS. 1-4, exemplary arrangements and details of equipping devices 70 are explained hereinafter with reference to FIGS. 5-14. The equipping devices 70 are suitable for loading tool magazines 60. In this way, tools 66 can be loaded or unloaded. Placing a tool 66 in the access opening 74 or removing a tool 66 from the access opening 74 can be performed by an operator during production time, if required.

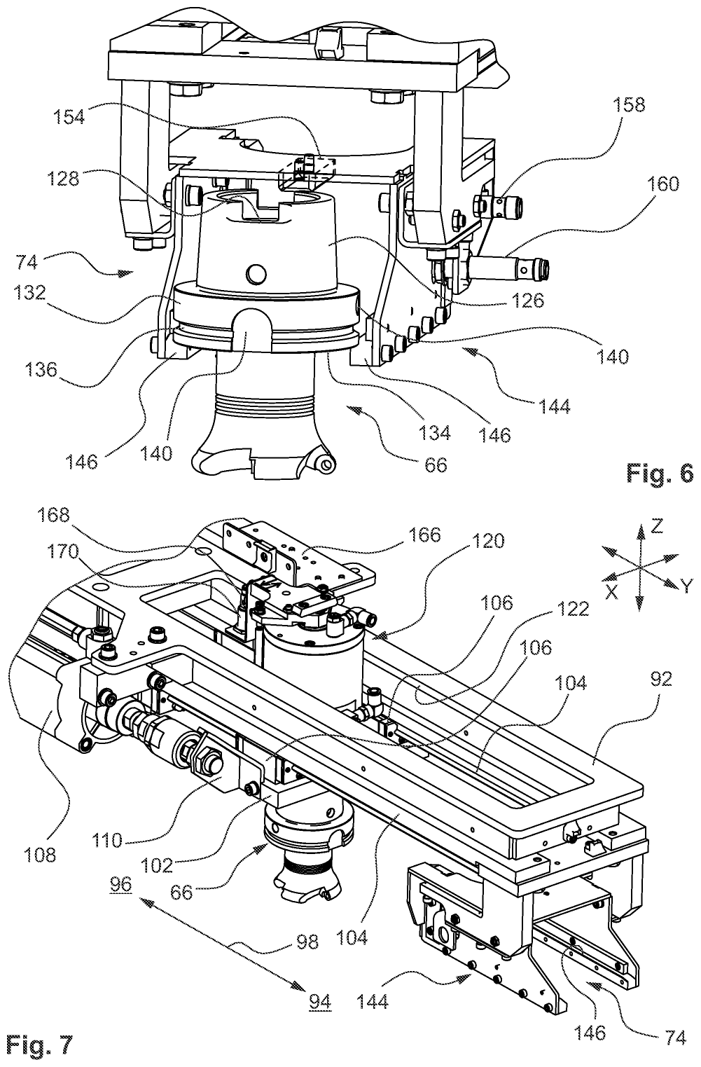

FIG. 5 shows a perspective view of an equipping device 70, from below. FIG. 7 shows a corresponding partial perspective view, from above. FIG. 6 illustrates a detail of an access opening 74.

The equipping device 70 comprises a tool shuttle 90, which is mounted to a support 92 that is fixed to the frame. The tool shuttle 90 is movable between a first transfer position 94 and a second transfer position 96. In FIG. 3, a double arrow indicated by 98 illustrates the corresponding travel path. By way of example, the tool shuttle 90 is linearly movable, cf. also the double arrow 72 in FIG. 2, which illustrates the transfer movement between access opening 74 and tool magazine 60.

The tool shuttle 90 comprises a base body 102, which is arranged as a base plate in the exemplary embodiment. The base body 102 is mounted via carriages 106 on guides 104, which are attached to the support 92 that is fixed to the frame. In the exemplary embodiment, two guides 104 are associated with each other and oriented parallel to the travel path 98. The base body 102 of the tool shuttle 90 comprises four carriages 106, two carriages 106 of which are respectively mounted on one of the two guides 104. The tool shuttle 90 is driven by a drive 108, which is arranged, for example, as a cylinder. The drive 108 acts on a driver 110, which is attached to the base body 102 of the tool shuttle 90, see also FIG. 7. Furthermore, in FIG. 5, 114 indicates a supply line that is arranged as a so-called cable drag chain. The supply line 114 connects the tool shuttle 90 to the support 92 that is fixed to the frame. In this way, information, energy and operating media can be transmitted independently of a current position of the tool shuttle 90.

The tool shuttle 90 of the equipping device 70 further supports a tool carrying unit 120. The tool carrying unit 120 is configured to grip a tool 66. In this way, the tool 66 can be secured to the tool shuttle 90 and transferred between the first transfer position 94 and the second transfer position 96 by movement of the tool shuttle 90. At the second transfer position 96, a transfer occurs between the tool shuttle 90 of the equipping device 70 and a magazine location 64 of a tool magazine 60 (cf. also FIG. 2). In the illustrated embodiment, the tool carrying unit 120 protrudes through an opening 122 in the support 92, cf. FIG. 7.

In each of FIGS. 5 and 6, a tool 66 is held at the tool shuttle 90 by the tool carrying unit 120. In FIG. 6, a tool 66 that is ready for pick-up is in a provision position at the access opening 74.

The tool 66 is for instance a drilling tool, a milling tool or the like, generally a tool for machining. The tool 66 includes a machining portion 124 and a hollow shaft 126 that is facing away from the machining portion 124. The machining portion 124 may include at least one cutting edge. The tool carrying unit 120 is configured to at least partially engage the hollow shaft 126 of the tool 66 to grip and secure the tool 66 via the hollow shaft 126. In the exemplary embodiment, the hollow shaft 126 comprises at its end two recesses 128 that are offset by 180° with respect to each other, which can be used to ensure a desired rotational orientation of the tool 66 in the equipping device 70.

The tool 66 involves a longitudinal axis 130. The hollow shaft 126 is at least partially concentric with the longitudinal axis 130. The tool 66 further comprises a handling portion 132 that is arranged between the hollow shaft 126 and the machining portion 124. The handling portion 132 may be a circumferential bead having functional elements for handling. In the embodiment, the handling portion 132 includes a support surface 134, a handling groove 136, and at least one orientation groove 138. Furthermore, FIGS. 5 and 6 indicate a recess 140 in the handling portion 132 that is configured to receive a tool identifier, for example.

A provision location 144 is used to provide a tool 66 for pick-up by the tool carrying unit 120. FIG. 6 shows an enlarged view of the provision location 144. In FIG. 6, a tool 66 is fed to the provision location 144 via the access opening 74. The tool 66 sits with the support surface 134 of the handling portion 132 on two lateral provision supports 146. The tool 66 can be disposed manually by the operator. Stops 150 are also provided at the provision location 144 (shown in FIG. 5, obscured by the tool 66 in FIG. 6), which ensure that the inserted tool 66 is ready in the first transfer position 94 and cannot be pushed beyond it.

FIG. 6 further shows, by means of a partially dashed (because hidden) illustration, an orientation guide 154 that is arranged at the provision location 144 to ensure a desired orientation of the recesses 128 of the hollow shaft 126 when the tool 66 is inserted. In this way, the tool 66 can be deposited at the provision location 144 only in a desired preferred orientation to be ready for pick-up by the tool carrying unit 120 at the first transfer position 94.

FIG. 6 further shows two sensors 158, 160 that are provided at the provision location 144 to monitor the provision of the tool 66. By way of example, the sensor 158 is a proximity sensor that is aimed at the hollow shaft 126 of the tool 66. The proximity sensor 158 detects the presence of the hollow shaft 126 when the tool 66 is pushed far enough on the provision support 146 towards the first transfer position 94. By way of example, the sensor 160 is a sensor for detecting the recess 140. In an exemplary embodiment, the sensor 160 is configured to detect the presence of the recess 140. In an exemplary embodiment, the sensor 160 is configured to read a tool identifier that is located in the recess 140.

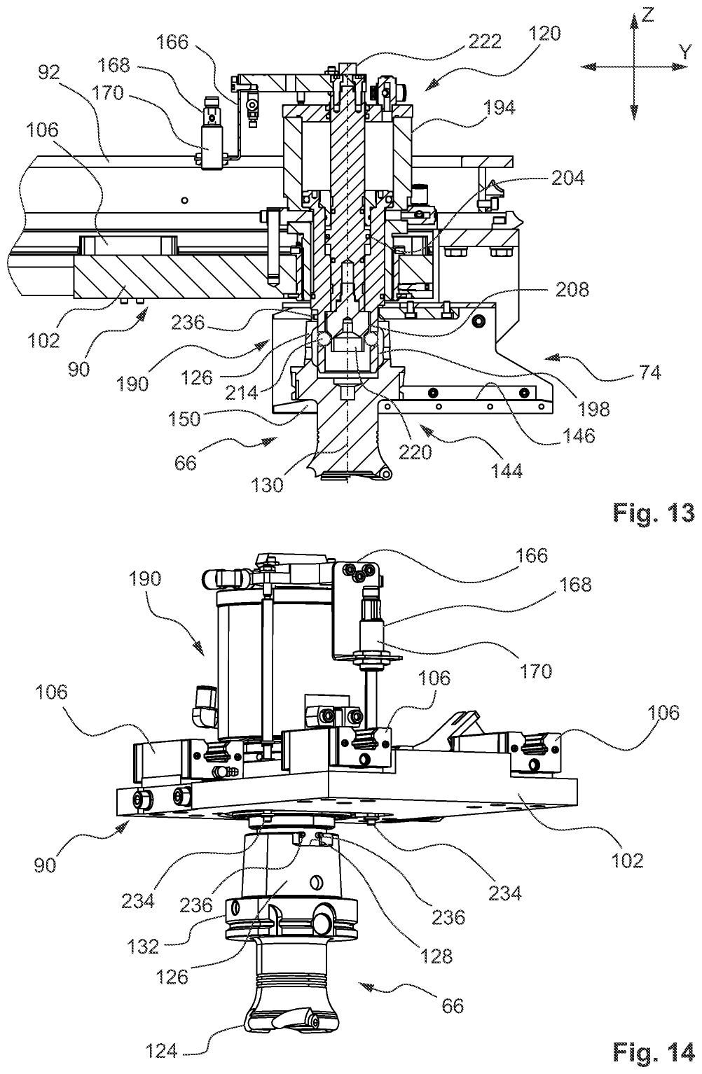

FIG. 7 further shows that in the embodiment, the tool carrying unit 120 carries a cantilever 166 that is arranged at an end of the tool carrying unit 120 that is facing away from the tool 66. In the exemplary embodiment, the cantilever 166 sits above the support 92, cf. also FIG. 13. The cantilever 166 carries a position monitoring unit 168 with at least one proximity sensor 170. In the illustrated configuration, the cantilever 166 is vertically movable when the tool carrying unit 120 is actuated to engage a hollow shaft 126 of a tool 66 via a gripping mechanism (compare reference numeral 190 in FIG. 10) and to secure the tool 66. In this way, the operating state of the tool carrying unit 120 can be monitored.

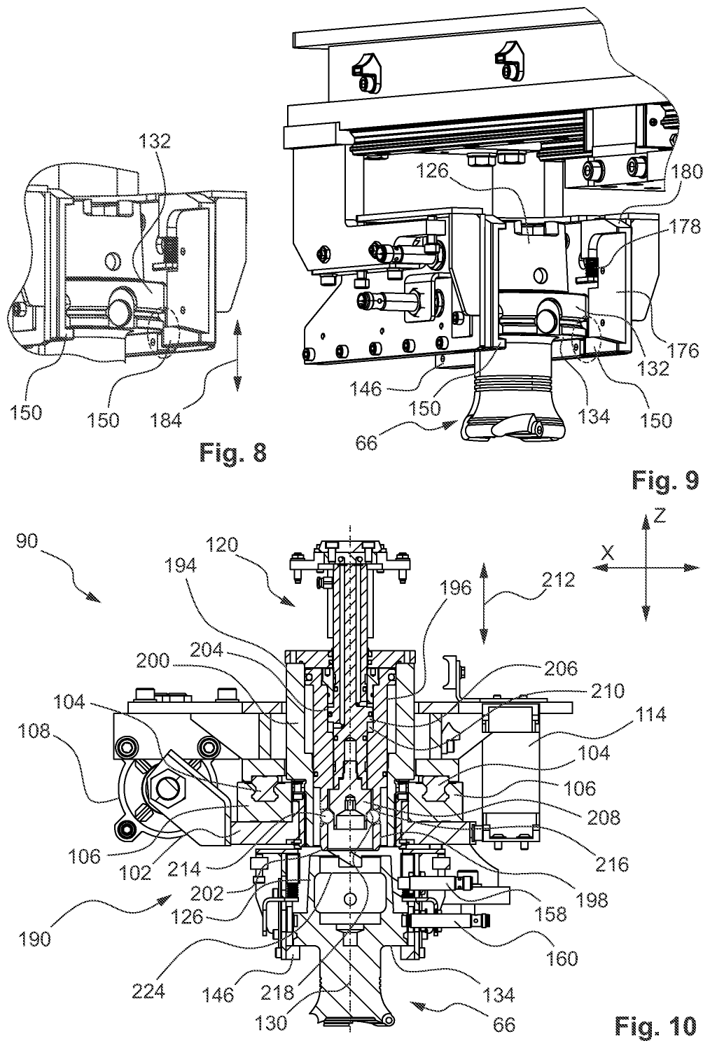

FIGS. 8 and 9 illustrate the stops 150 of the provision location 144, cf. also FIG. 5. FIG. 8 shows the stops 150 in a locked position. FIG. 9 shows the stops 150 in a release position. At the provision location 144, the stops 150 follow the provision support 146. A tool 66 placed there can be pushed up to the stops 150. When the tool 66 comes to rest there with the handling portion 132, it is in the first transfer position 94. The tool 66 is ready to be taken over by the tool carrying unit 120 of the tool shuttle 90. In FIG. 8, a double arrow 144 indicates that the stops 150 are movable.

The stops 150 are formed on a body 176, which is acted upon by a biasing element 178. The biasing element 178 urges the stop 150 towards the locked position shown in FIG. 8. In the locked position, the tool 66 cannot be translationally moved by the tool shuttle 90 from the first transfer position 94 to the second transfer position 96, cf. the travel path 98 shown in FIGS. 5 and 7. To move a stop 150 to the release position shown in FIG. 9, the tool shuttle 90 can act on a control surface 180 on the body 176 of the stop 150 as it approaches. When the stops 150 assume the release position shown in FIG. 9, the tool 66 can slide with its support surface 134 over the stops 150.

With additional reference to FIGS. 10-13, the configuration of the tool carrying unit 120 of the equipping device 70 is illustrated in more detail. FIGS. 10-12 each show a cross-section through a tool shuttle 90 of the equipping device 70, wherein different positions of the tool carrying unit 120 relative to a tool 66 are shown. FIG. 13 shows a longitudinal section through a tool shuttle 90 of the equipping device 70. The position shown in FIG. 13 corresponds to that of FIG. 11.

The tool carrying unit 120 comprises a gripping mechanism 190, which comprises a guide cylinder 194 with a guide piston 196. At an end 202 of the guide piston 196 that is facing the tool 66, there is a guide element 198 that can at least partially enter the hollow shaft 126 of the tool 66. The guide piston 196 is disposed in a carrying housing 200 that is attached to the base body 102 of the tool shuttle 90. The gripping mechanism 190 further comprises a securing cylinder 204 comprising a securing piston 206. A securing element 208 is seated at an end 220 (FIG. 13) of the securing piston 206 that is facing the tool 66, wherein the securing element 208 can at least partially enter the hollow shaft 126 of the tool 66. The securing piston 206 is seated in a recess 210 in the guide piston 196. The guide cylinder 194 and the securing cylinder 204 together form a telescopic pair of cylinders.

In the exemplary embodiment, the guide piston 196 is arranged concentric to the longitudinal axis 130 of the tool 66. In the exemplary embodiment, the securing piston 206 is arranged concentrically to the longitudinal axis 130 of the tool 66. The guide piston 196 and the securing piston 206 are movable parallel to the longitudinal axis 130 and/or along the longitudinal axis 130, respectively, cf. the double arrow 212. The guide piston 196 is movable relative to the carrying housing 200 and thus relative to the base body 102 of the tool shuttle 90. The guide piston 196 and the securing piston 206 are movable relative to each other. A movement range of the guide piston 196 is defined by the carrying housing 200 of the guide cylinder 194. A range of movement of the securing piston 206 is defined by the recess 210 in the securing cylinder 204.

Due to the considerable vertical extension of the carrying housing 200, there is a considerable travel distance for the guide piston 196. The vertical extent of the recess 210 is significantly smaller, resulting in a smaller travel distance for the securing piston 206. When the guide piston 196 is moved, the securing piston 206 is basically also moved. The movement of the securing piston 206 relative to the guide piston 196 comprises a small offset stroke.

The guide element 198 and the securing element 208 cooperate to secure the tool 66 to the gripping mechanism 190 via its hollow shaft 126. For this purpose, the gripping mechanism 190 comprises latching elements 214, which are arranged, for example, as latching balls. The latching elements 214 are seated, at least in sections, in latching recesses 216 in the guide element 198. The securing element 208 comprises a displacement section 218, which is configured, for example, as a cone. The displacement portion 218 can urge the latching elements 214 radially outward as the securing element 208 is moved relative to the guide element 198 towards the tool 66 during movement of the securing piston 206.

In the position shown in FIG. 10, the gripping mechanism 190 with the guide element 198 and the securing element 208 is not yet engaged in the hollow shaft 126 of the tool 66. A latching portion 224 is formed in the hollow shaft 126, which includes an undercut formed by a shoulder. The latching elements 214 can engage at the latching portion 224 when the securing element 208 with the displacement section 218 urges the latching elements 214 radially outwardly there.

In the position shown in FIG. 11, the gripping mechanism 190 with the guide element 198 is inserted into the hollow shaft 126 of the tool 166. The tool 66 and the guide element 198 are concentrically aligned with each other. However, the tool 166 is not yet secured to the gripping mechanism 190. The latching elements 214 are not yet displaced outwardly by the displacement portion 218 towards the latching portion 224 of the tool 66.

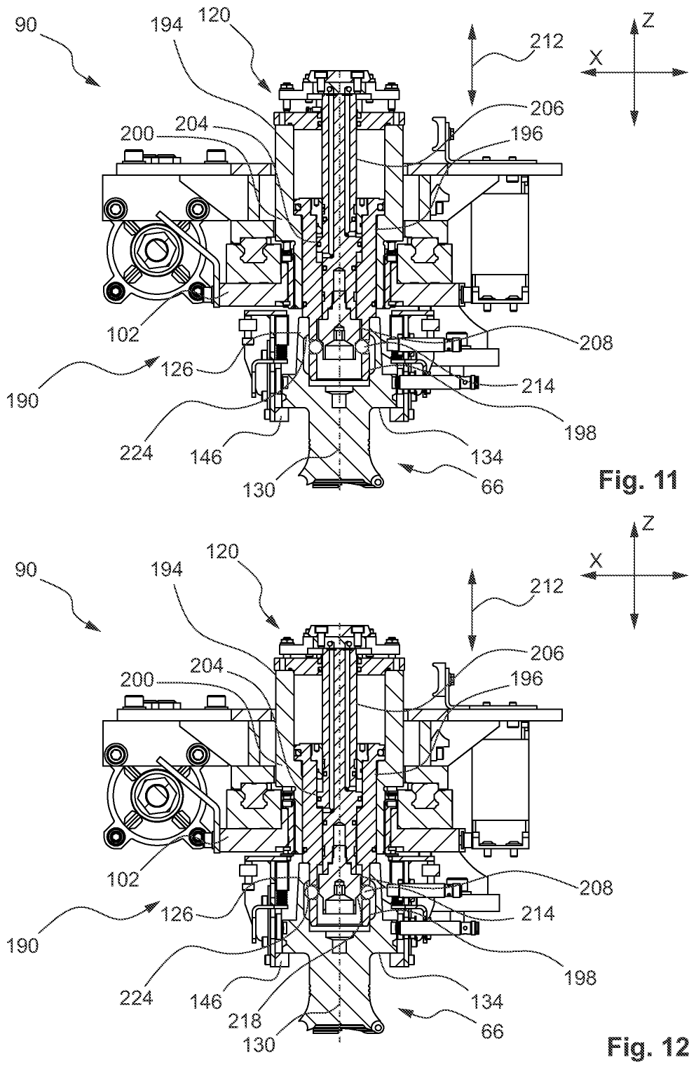

Such a state is shown in FIG. 12. This state is achieved by moving the securing piston 206 further towards the tool 66 relative to the guide piston 196. This causes the accompanying displacement of the securing element 208 and the displacement section 218 to engage the latching elements 214 in the latching portion 224. In this state, the tool 66 cannot fall off the gripping mechanism 190. The tool 66 can be lifted (by a slight lift, if necessary) from the provision location 166 and moved from the first transfer position 94 towards the second transfer position 98 by the tool shuttle 90 for delivery to a tool magazine 60.

The guide cylinder 194 and the securing cylinder 204 can be fluidically controlled, for example pneumatically. In addition to the guide cylinder 194, the securing cylinder 204 forms a further offset stage that enables the tool 66 to be locked. The tool 66 is securely locked to the gripping mechanism 190 of the tool carrying unit 120. In the exemplary embodiment, this is accomplished by engaging the hollow shaft 126 of the tool and locking it there. Therefore, the handling portion 132 of the tool 66 is available for further handling operations. By way of example, the tool 66 can be deposited with the handling groove 136 of the handling portion 132 in a magazine location 64 of a tool magazine 60.

FIG. 13 illustrates by means of a longitudinal section the interaction of the gripping mechanism 190 with the cantilever 166 with the position monitoring unit 170 and the at least one proximity sensor 168, cf. also FIG. 7 and FIG. 14. In the exemplary embodiment, the cantilever 166 is arranged at an end 222 of the securing piston 206 that is facing away from the tool 66. The securing piston 206 is also moved when the guide piston 196 is moved. Thus, the proximity sensor 170 can also detect and monitor the position of the guide piston 196. The relative movement between the securing piston 206 and the guide piston 196 takes place, for example, after the guide piston 196 has moved with respect to the carrying housing 200 of the guide cylinder 194. If there were a misalignment between the securing piston 194 and the guide piston 196, the guide element 198 might not even be able to enter the hollow shaft 126 of the tool 66. Overall, both movements can thus be monitored with only one proximity sensor 170.

By way of example, the guide cylinder 194 and the securing cylinder 204 are double-acting cylinders. Starting from the position of the gripping mechanism 190 shown in FIG. 13, the tool 66 can be locked to the tool carrying unit 120. Then, if necessary, the tool 66 can be lifted a short distance from the provision support 146. In the position shown in FIG. 13, the tool shuttle 90 is in the first transfer position 94. Thus, the tool shuttle 90 has moved the stop 150 to the release position. The tool 66 can overcome the stop 150 as it moves towards the second transfer position 96.

FIG. 14 shows the tool shuttle 90 in a state detached from further components of the equipping device 70. In the exemplary embodiment, two sliding pieces 234 are provided on the base body 102 that are configured to contact and displace the control surfaces 180 of the stops 150 as the tool shuttle 90 moves towards the first transfer position 94. In this way, the stops 150 are movable from the locking position to the release position by the tool shuttle 90 against the force of the preloading element 178, cf. again FIG. 8 and FIG. 9.

FIG. 14 further shows two orientation guides 236, which ensure the relative orientation of the recesses 128 at the hollow shaft 126 of the tool 66. In the exemplary embodiment, the orientation guides 236 are arranged at the guide piston 196.

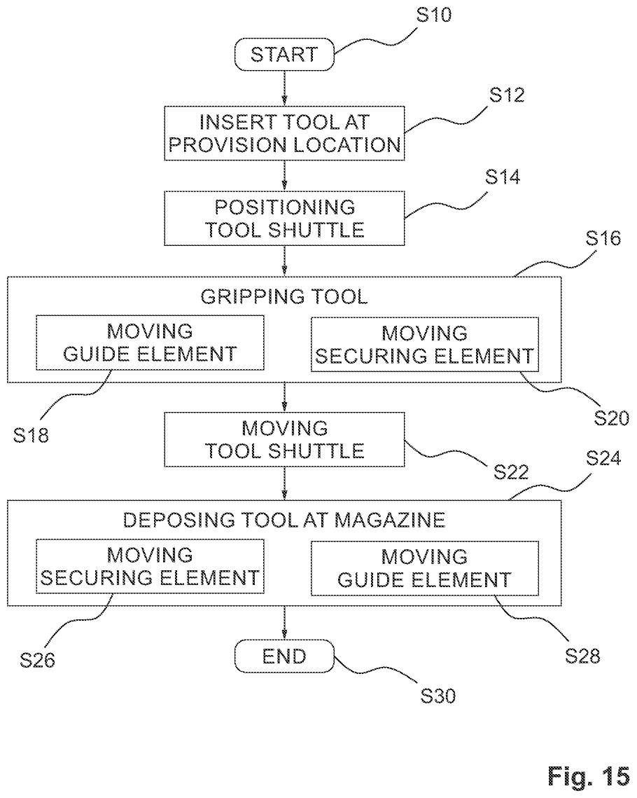

FIG. 15 illustrates by means of a schematic block diagram an exemplary embodiment of a method for loading or unloading tools in a machine tool according to at least one of the embodiments described herein. In the exemplary embodiment, the method starts at a step S10.

In a step S12, a tool is inserted into the provision location of the equipping device. This can be done manually by an operator. The tool can already be favorably aligned at the provision location for the transfer by the tool carrying unit.

A step S14 comprises positioning the tool shuttle in the first transfer position where the tool is ready. By way of example, the tool carrying unit with gripping mechanism is aligned concentrically to the longitudinal axis of a provided tool.

A step S16 comprises gripping the tool by the gripping mechanism. In a substep S18, this comprises a movement of the guide element (together with the securing element), for example into the hollow shaft of the tool. Furthermore, in a sub-step S20, the securing element is moved relative to the guide element to lock the tool to the gripping mechanism. Usually, substep S20 follows substep S18.

This is followed by step S22, which involves moving the tool shuttle from the first transfer position to the second transfer position. There, an empty magazine location is available in the tool magazine, to which the tool can be transferred. In an exemplary embodiment, the tool is therefore already adequately secured in the tool magazine when the tool shuttle has reached the second transfer position. This is done, for example, via the handling groove on the handling portion of the tool, which is not occupied by the gripping mechanism.

A step S24 comprises deposing the tool and releasing the gripping mechanism. This includes a substep S26, in which the securing element is moved relative to the guide element to unlock the secured position of the tool. This can be followed by a substep S28, in which the guide element (together with the securing element) is moved out of the hollow shaft of the tool. The tool shuttle can then be moved away from the second transfer position.

In the illustrated embodiment, the method ends at step S30. In certain embodiments, the method can be run backwards to unload tools from a tool magazine. It is understood that the method can also comprise steps that include a rearrangement of tools in the tool magazine using the tool spindle. This is also useful if several tool magazines are provided that can be reached by the tool spindle.

What is claimed is:

1. An equipping device for a tool magazine of a machine tool, comprising:
a tool shuttle that is movable between a first transfer position and a second transfer position,
a provision location for insertion or removal of tools,
a tool carrying unit that is associated with the tool shuttle and comprises at least one gripping mechanism that is arranged to grip a tool to be transferred and to secure it to the tool shuttle,
wherein the tool shuttle is configured to exchange the tool between the provision location and a magazine location of a tool magazine,
wherein the provision location is accessible for the tool shuttle in the first transfer position,
wherein the magazine location is accessible for the tool shuttle in the second transfer position,
wherein the gripping mechanism comprises a guide element that is movable relative to a base body of the tool shuttle and a securing element that is movable relative to the guide element, and
wherein the guide element is movable parallel to a longitudinal axis of the tool.

2. The equipping device of claim 1,
wherein the guide element and the securing element are movable parallel to the longitudinal axis of the tool.

3. The equipping device of claim 1,
wherein the provision location is externally accessible via an access opening for inserting and removing tools.

4. The equipping device of claim 1,
wherein the guide element is configured to move into a hollow shaft of the tool to take up the tool.

5. The equipping device of claim 1,
wherein the securing element is movable relative to the guide element to secure a gripped tool positively or non-positively at the guide element.

6. The equipping device of claim 5,
wherein the securing element is movable parallel to the longitudinal axis of the tool relative to the guide element to engage at least one latching portion of the tool with at least one latching element.

7. The equipping device of claim 1,
wherein the guide element is part of a guide cylinder that is mounted to the base body.

8. The equipping device of claim 1,
wherein the securing element is part of a securing cylinder that is coupled to the guide element.

9. The equipping device of claim 1,
wherein the guide element is part of a guide piston, and
wherein the guide piston is movable parallel to the longitudinal axis of the tool in a carrying housing.

10. The equipping device of claim 9,
wherein the guide element is formed at an end of the guide piston that is facing the tool.

11. The equipping device of claim 9,
wherein the guide element is oriented concentrically to the longitudinal axis of the tool when the tool is gripped.

12. The equipping device of claim 1,
wherein the securing element is part of a securing piston, and
wherein the securing piston is movable parallel to the longitudinal axis of the tool in a carrying housing.

13. The equipping device of claim 12,
wherein the securing element is formed at an end of the securing piston that is facing the tool.

14. The equipping device of claim 12,
wherein the securing element is aligned concentrically with the guide element.

15. The equipping device of claim 12,
wherein the securing piston comprises an end that is facing away from the tool,
wherein the securing piston protrudes through the guide piston at the end that is facing away from the tool, and
wherein the securing piston comprises at the end that is facing away from the tool a cantilever, which cooperates with a position monitoring unit that is arranged on the base body.

16. The equipping device of claim 15,
wherein the position monitoring unit is configured to detect a position of the guide piston and a position of the securing piston via the cantilever.

17. The equipping device of claim 1,
wherein the tool carrying unit is movable together with the tool shuttle between the first transfer position and the second transfer position.

18. The equipping device of claim 1,
wherein the tool rests at the provision location with a handling portion on a stationary provision support.

19. The equipping device of claim 18,
wherein the tool is retained in the tool magazine in the magazine location via the handling portion.

20. The equipping device of claim 1,
wherein at least one mechanical orientation guide for ensuring a rotational orientation of an inserted tool or at least one proximity sensor for detecting an inserted tool is arranged at the provision location.

21. The equipping device of claim 1,
wherein at the provision location at least one stop for a tool that is presented in the first transfer position is provided, and
wherein the tool shuttle is configured to bring the stop from a locking position into a release position.

22. A machine tool comprising:
a frame,
at least one workpiece support,
at least one tool spindle that is movable relative to the workpiece support,
at least one tool magazine that is associated with the tool spindle for providing a plurality of tools, and
at least one equipping device for loading and unloading the tool magazine, the at least one equipping device comprising:
a tool shuttle that is movable between a first transfer position and a second transfer position,
a provision location for insertion or removal of tools,
a tool carrying unit that is associated with the tool shuttle and comprises at least one gripping mechanism that is arranged to grip a tool to be transferred and to secure it to the tool shuttle,
wherein the tool shuttle is configured to exchange the tool between the provision location and a magazine location of the tool magazine,
wherein the provision location is accessible for the tool shuttle in the first transfer position,
wherein the magazine location is accessible for the tool shuttle in the second transfer position,
wherein the gripping mechanism comprises a guide element that is movable relative to a base body of the tool shuttle and a securing element that is movable relative to the guide element,
wherein the guide element is movable parallel to a longitudinal axis of the tool, and
wherein the provision location is externally accessible via an access opening for inserting and removing tools.

23. The machine tool of claim 22,
wherein the tool spindle is arranged to grip tools that are provided by the at least one tool magazine in a pick-up process.

24. The machine tool of claim 22, comprising
a first tool magazine,
a second tool magazine, and
a single equipping device,
wherein the equipping device is operatively coupled to the first tool magazine for loading or unloading tools, and
wherein the tool spindle is arranged to transfer the tools between the first tool magazine and the second tool magazine.

25. A method for loading or unloading tools in a machine tool, comprising the steps of:
providing an equipping device for a tool magazine of a machine tool, the equipping device comprising:
a tool shuttle that is movable between a first transfer position and a second transfer position,
a provision location for insertion or removal of tools,
a tool carrying unit that is associated with the tool shuttle and comprises at least one gripping mechanism that is arranged to grip a tool to be transferred and to secure it to the tool shuttle,
wherein the tool shuttle is configured to exchange the tool between the provision location and a magazine location of a tool magazine,
wherein the provision location is accessible for the tool shuttle in the first transfer position,
wherein the magazine location is accessible for the tool shuttle in the second transfer position,
wherein the gripping mechanism comprises a guide element that is movable relative to a base body of the tool shuttle and a securing element that is movable relative to the guide element, and
wherein the guide element is movable parallel to a longitudinal axis of the tool,
loading a tool into the provision location,
positioning the tool shuttle in the first transfer position so that the tool is accessible for the tool carrying unit,
controlling the tool carrying unit to move the guide element and the securing element to grip the tool and to secure it to the tool shuttle,
moving the tool shuttle to the second transfer position where a magazine location of the tool magazine is available, and
handing over the tool to the magazine location of the tool magazine, comprising a movement of the guide element and the securing element.
